(19) United States
(12) Patent Application Publication
(10) Pub. No.: US 2015/0015222 A1
(43) Pub. Date: Jan. 15, 2015

(54) LOW DROPOUT VOLTAGE REGULATOR

(71) Applicants: Texas Instruments Deutschland GMBH, Freising (DE); Texas Instruments Incorporated, Dallas, TX (US)

(72) Inventors: Vadim Valerievich Ivanov, Denton, TX (US); Sudipto Chakraborty, Richardson, TX (US); Jens Graul, Freising (DE)

(21) Appl. No.: 13/938,085

(22) Filed: Jul. 9, 2013

(51) Int. Cl. G05F 1/46

(52) U.S. Cl. CPC G05F 1/46
USPC 323/273

(57) ABSTRACT

Voltage regulators are disclosed herein. An embodiment of a voltage regulator includes a MOS-type pass transistor, wherein a first node of the pass transistor is connectable to a voltage source and wherein a second node of the pass transistor is connected to the output of the voltage regulator. The voltage regulator also includes an error amplifier having a reference input and an output, the output being connected to the gate of the pass transistor, and the reference input being connected to a reference voltage source.

### BACKGROUND

Low dropout voltage regulators (LDOs) use a pass transistor that conducts current from a source to a load. The amount of current and, thus, the voltage of the output, is controlled by the gate voltage of the pass transistor. The output voltage of the voltage regulator is fed back to an error amplifier that compares the output voltage to a reference voltage. The difference between the two voltages is used to generate the gate voltage of the pass transistor. Therefore, if the output voltage is too low, the error amplifier generates a gate voltage that causes the pass transistor to conduct more current, which increases the output voltage. Likewise, if the output voltage is too high, the error amplifier generates a voltage that causes the pass transistor to pass less current, which lowers the output voltage.

Low dropout voltage regulators are used as voltage supplies in some radio circuits. The voltage supplies in the radios typically require low voltage supply noise at frequencies above 10-20 kHz. Higher frequency noise may interfere with the performance of the radios. In order to conserve power, the circuits in the radios draw very little current, which increases noise. In order to overcome noise, conventional voltage regulators used in radio circuits may have a large capacitance connected to the output of the LDO. However, many radio circuits use a plurality of different power domains, which requires the use of many large capacitors. These capacitors are typically external to the radio circuits and add costs and size to the radios.

Another method of reducing noise is by running large currents through the error amplifier. For example, currents in the range of one half to two milliamps may be used. The noise is inversely proportional to the square of the current in the input stage of the error amplifier, so a higher current results in lower noise. However, the high current has many drawbacks, especially when the radio is a battery-powered device. The most notable drawback is that the higher current reduces the battery life of the battery-powered radio.

### SUMMARY

Voltage regulators are disclosed herein. An embodiment of a voltage regulator includes a MOS-type pass transistor, wherein a channel of the pass transistor is connectable to a voltage source and wherein a second channel of the pass transistor is connected to the output of the voltage regulator. The voltage regulator also includes an error amplifier having a reference input and an output, the output being connected to the gate of the pass transistor, and the reference input being connected to a reference voltage source.

### BRIEF DESCRIPTION OF THE DRAWINGS

FIG. 1 is a schematic diagram of an embodiment of a low dropout voltage regulator.

FIG. 2 is a schematic diagram of another embodiment of a low dropout voltage regulator.

FIG. 3 is a schematic diagram of another embodiment of a low dropout voltage regulator.

FIG. 4 is a schematic diagram of another embodiment of a low dropout voltage regulator.

### DETAILED DESCRIPTION

Low dropout voltage regulators and methods of regulating voltage are disclosed herein. The low dropout voltage regulators are sometimes referred to simply as LDOs or regulators. The LDOs disclosed herein use a very slow error amplifier so the closed-loop LDO bandwidth is below a predetermined frequency. For example, the closed-loop LDO bandwidth may be below 10-20 kHz, which can be achieved by using very small biasing current (10-20 nA) in the input stage as described below. The output noise at frequencies outside of the closed-loop bandwidth is defined by the noise of the pass transistor which is inversely proportional to the square root of the load current. Therefore, a greater load current results in lower noise at the frequencies of interest.

In conventional applications, a low closed-loop bandwidth in the LDO causes long settling times of the output voltage when the load is switched. The LDOs disclosed herein eliminate the loading problem by using class AB input stages in the error amplifier. At steady state, when the load is constant, the error is small and current flow through the error amplifier is small. However during load transients the current flow may rise, which increases the closed-loop bandwidth and ensures very fast settling of the output voltage.

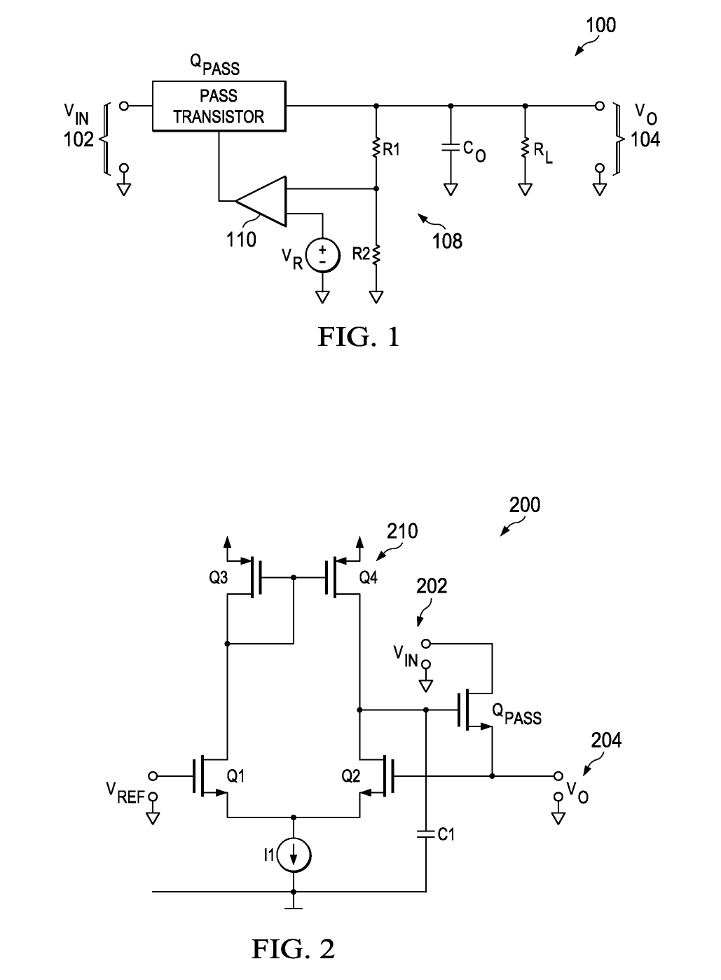

Having briefly described the LDOs, different embodiments will now be described in greater detail. Reference is made to FIG. 1, which is a schematic illustration of a LDO 100, which is sometimes referred to herein as the regulator 100. The regulator 100 has an input 102 that receives an input voltage V_{IN}, such as a DC voltage. The DC voltage may have some ripple or noise caused by its generation. The regulator 100 has an output 104 wherein a regulated output voltage V_{O} is output.

The regulator 100 includes a pass transistor Q_{PASS}, which may be a field effect transistor (FET), connected or coupled between the input 102 and the output 104. The pass transistor Q_{PASS} may operate in open collector or open drain mode, which enables it to operate in the saturation mode or close to the saturation mode. The drain and source may be referred to generically as channels. In the saturation mode, the voltage drop across the pass transistor Q_{PASS} between the input 102 and the output 104 is very small, which enables the regulator 100 to operate efficiently. In some embodiments, the pass transistor Q_{PASS} is a bipolar junction transistor. In other embodiments, the pass transistor Q_{PASS} may be an NMOS-type device or a PMOS-type device.

A voltage divider 108 provides feedback of the output voltage V_{O}. In the embodiment of FIG. 1, the voltage divider 108 consists of two resistors, R1 and R2, connected in series. An error amplifier 110 monitors the output of the voltage divider 108 and compares it to a reference voltage V_{R}. The voltage divider 108, using series resistors, consumes current from the output 104 of the regulator 100, which may not be conducive with low-power applications. In order to overcome this problem, some embodiments of the error amplifier 110 monitor the output voltage V_{O} directly without any voltage divider.

The voltage reference V_{R} is the replica of or is proportional to the replica of the required output voltage V_{O} at the output 104. As the load on the output 104 changes, the output voltage V_{O} may not be equal to the reference voltage V_{R}. The regulator 100 resolves this problem so that a predetermined and regulated output voltage Vₒ is output at the output 104. More specifically, the regulator 100 functions to make the output voltage Vₒ equal to the required output voltage, which is equal to or proportional to the reference voltage V_{R}. The output of the error amplifier 110 is connected to or coupled to the gate or base of the pass transistor Q_{PASS}. The voltage output by the error amplifier 110 regulates the current flow through the pass transistor Q_{PASS}, which is used to maintain the output voltage V_{O}.

A capacitor C_{O} may be connected to the output 104. The capacitor C_{O} attenuates noise and/or ripple on the output 104. In some embodiments, the regulator 100 is able to attenuate noise and ripple at the output by way of the voltage regulation, so the capacitor C_{O} is not required. A resistance R_{L} is representative of the load connected to the regulator 100. As items are connected to and disconnected from the regulator 100, the value of the load R_{L} changes accordingly. As described above, the regulator 100 is fast enough to maintain a constant output voltage V_{O} as the load R_{L} on the output 104 changes.

Having described the components of the regulator 100, its operation will now be described. The input voltage V_{IN} is present at the input 102, which is connected to the pass transistor Q_{PASS}. The pass transistor Q_{PASS} enables current to flow to the output 104 based on the gate or base voltage, which is the voltage output by the error amplifier 110 or is a voltage that is proportional to the voltage output by the error amplifier 110. The output voltage V_{O} is measured by way of the voltage divider 108 and input to the error amplifier 110. Accordingly, the output voltage V_{O} or a voltage proportional to the output voltage V_{O} is compared to the reference voltage V_{R}. If the output voltage V_{O} is too low, the error amplifier 110 causes the pass transistor Q_{PASS} to output more current, which increases the output voltage V_{O}. Likewise, if the output voltage V_{O} is too high, the error amplifier 110 causes the pass transistor Q_{PASS} to reduce the current flow, which reduces the output voltage V_{O}.

An embodiment of a voltage regulator 200 is shown in FIG. 2. The regulator 200 has an input 202 that has a voltage V_{IN} and an output 204 with a voltage V_{O}. The regulator 200 includes an error amplifier 210 consisting of a plurality of transistors, which may be metal oxide semiconductor field effect transistors (MOSFETs) or other devices known by those skilled in the art. The error amplifier 210 may operate in class AB. The error amplifier 210 includes a first transistor Q1 that is connected to a reference voltage V_{REF}. The gate of a second transistor Q2 is connected to the output 204 to provide feedback to the error amplifier 210. The sources of the transistors Q1 and Q2 are connected to a current source I1. The error amplifier 210 includes current mirror transistors Q3 and Q4. One of the features of the regulator 200 is the ability to draw a very small current, which may be approximately 10 nA. The bias current provided by the current source I1 is very low in order to keep the loop bandwidth of the regulator 100 below a predetermined frequency. For example, the low current may keep the loop bandwidth of the regulator 100 below 10 kHz or 20 kHz when the error amplifier 210 is operating in steady state mode.

The output of the error amplifier 210 is the drain of the transistor Q2, which is connected to the gate of the pass transistor Q_{PASS}. As with the regulator 100 of FIG. 1, the pass transistor Q_{PASS} controls the current flow between the input 202 and the output 204, which controls the output voltage. The pass transistor Q_{PASS} may be an NMOS device that provides very low noise characteristics. In other embodiments, the transistor Q_{PASS} may be a PMOS device. A capacitor C1 is connected between the drain of the transistor Q2 and ground. The capacitor C1 provides frequency compensation as well as reducing noise and power supply ripple that may otherwise be present at the output 204. Accordingly, high frequency noise that may adversely affect devices connected to the regulator 200 are attenuated or not amplified. The capacitor C1 affects the loop bandwidth of the regulator wherein the loop bandwidth is equal to gm/C1 where gm is the transconductance of the Q1/Q2 stage, which is proportional to the current I1.

The regulator 200 operates in a manner that is similar to the regulator 100 of FIG. 1. As shown in FIG. 2, the reference voltage V_{REF} is compared to the output voltage V_{O}. An error signal is generated at the drain of the transistor Q2, which regulates the current flow through the pass transistor Q_{PASS}. The noise in the NMOS pass transistor Q_{PASS} is proportional to the inverse of the square of the current. In high current applications, such as radios, the noise will be low. The error amplifier 210 operates at a very low loop bandwidth frequency, so that its noise is below the frequencies that would affect a device connected to the regulator 200. The result is that the error amplifier 210 operates at a very low current and low bandwidth, so the error amplifier 210 draws very little power and its noise may be inconsequential at frequencies above 5-10 kHz due to the low closed-loop bandwidth. More specifically, its noise will be out of the closed-loop bandwidth. The pass transistor Q_{PASS} operates at a high current, equal to the load current, which reduces its noise. Therefore, the regulator 200 operates with very little current and very little noise at high frequencies.

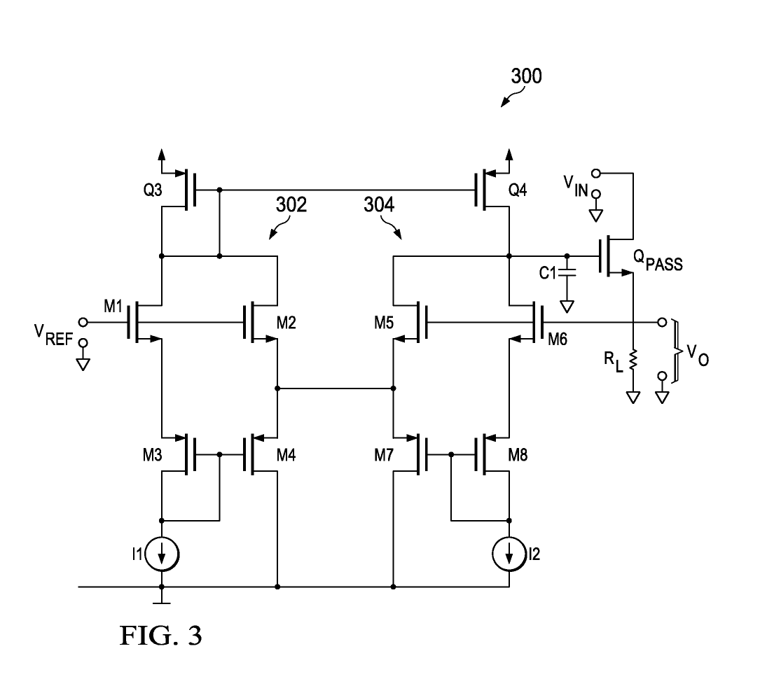

Another embodiment of an error amplifier 300 is shown in FIG. 3. The error amplifier 300 uses feedback to maintain minimal current draw. The error amplifier 300 is a differential amplifier having a first side 302 and a second side 304. The first side 302 has four transistors M1-M4 and the second side 304 has four transistors M5-M8. The reference voltage V_{REF} is input to the gate of the transistor M1, which is connected to the gate of the transistor M2. The drains of the transistors M1 and M6 are connected to a current mirror Q3 of FIG. 2. The source of the transistor M1 is connected to the source of the transistor M3. A current source I1 is connected between the drain of the transistor M3 and ground.

The second side 304 is the same or substantially the same as the first side 304. The output voltage V_{O} is connected to the gate of the transistor M6. A voltage source I2 is connected between the drain of the transistor M8 and ground. The two sides 302 and 304 are connected at the sources of the transistors M2 and M5. The drains of the transistors M5 and M6 are connected to the drain of the transistor Q4 and the gate of the pass transistor Q_{PASS}.

The transistors M5-M8 form a negative feedback loop that controls the minimum current flow through the transistor M5. When the load increases, which can be when the resistance R_{L} decreases, the output voltage V_{O} drops. The voltage drop causes the source voltage and the gate voltage of the transistor M8 to drop accordingly. With the gate voltage of the transistor M8 connected to the gate of the transistor M7, the gate to source voltage on the transistor M7 increases, which increases the current through the transistor M7. It follows that the tail current through the transistors M2 and M5 increases. It can be seen that the sum of the gate to source voltages of the transistors M5 and M7 is equal to the sum of the gate to source voltages of the transistors M6 and M8. The correlation can also be shown by the current where the product of the currents through the transistors M1 and M5 is equal to the current I_{O}²/4, where I_{O} is the current through the current source I2. The same operation applies to the first side 302 of the error amplifier 300. The increased current in the error amplifier 300 increases the closed-loop bandwidth so that the error amplifier 300 can quickly correct the output voltage V_{O}. During steady state operation, the current is low, so the bandwidth is low, which attenuates unwanted noise in the output voltage V_{O}.

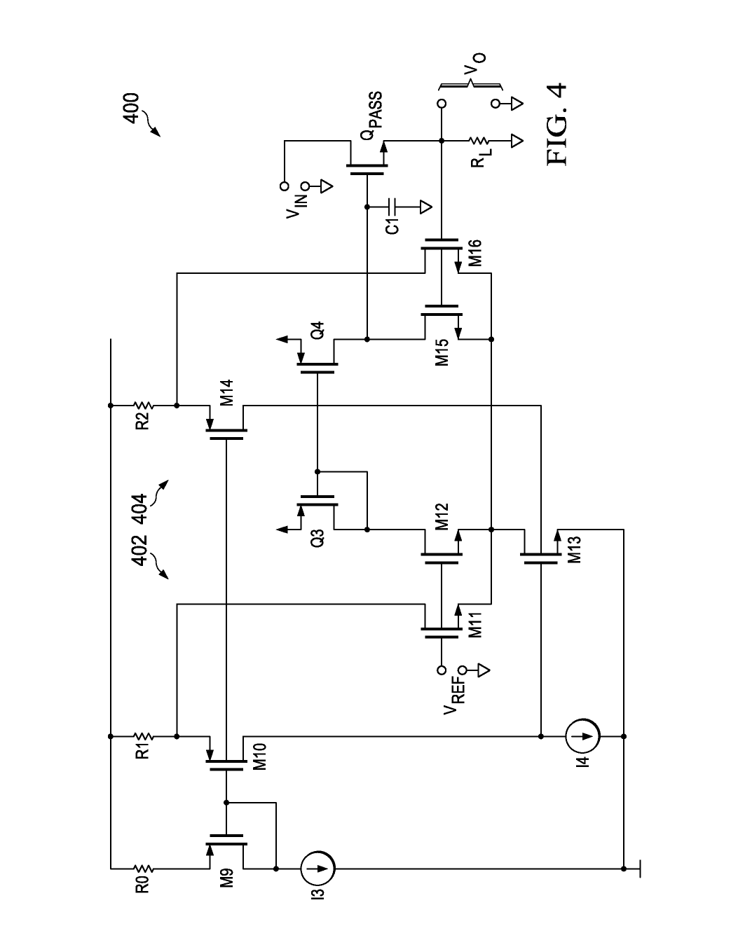

Another alternative embodiment of an error amplifier 400 is shown in FIG. 4. The error amplifier 400 performs a minimum current regulation that is very similar to the minimum current regulation in the error amplifier 300 of FIG. 3. The error amplifier 400 has a first side 402 and a second side 404 that are similar to the first and second sides 302, 304 of the error amplifier 300. The error amplifier 400 uses the transistors M10, M11, and M13 as a negative feedback loop for minimum current regulation on the first side 402. The transistors M13, M14, and M16 form a negative feedback loop for minimum current regulation on the second side 404. A current source I3 is connected between the drain of the transistor M9 and ground. A current source I4 is connected between the drain of the transistor M10 and ground.

In order to optimize the performance of the error amplifier 400, the transistors M9, M10, and M14 may be matched. In addition, the resistor R1 may have a value that is equal to the value of the resistor R2. The resistors R1 and R2 may have a value of half the resistance value of the resistor RO. In such embodiments, the current passing through the transistors M11 and M16 is equal to half the value of the current flowing through the current source I3. When the output voltage V_{O} decreases, the current through the transistor M16 decreases due to a drop in the gate to source voltage. This causes the current through the transistor M14 to increase. The result is that the current passing through the transistor M13 increases in order to maintain it at a value of half the current of the current source I4. The error amplifier 400 has a higher gain than the error amplifier 300 and better regulation of the minimum current. However, it does require the inclusion of resistors and matched transistors.

The regulators described above have been described with various transistors, such as N-type and P-type transistors. Those skilled in the art may switch the transistors to achieve the same results. In addition, other components may be added to the regulators described herein. The other components may include various regulators and biasing circuits as are well-known in the art.

While illustrative and presently preferred embodiments of the invention have been described in detail herein, it is to be understood that the inventive concepts may be otherwise variously embodied and employed and that the appended claims are intended to be construed to include such variations except insofar as limited by the prior art.

What is claimed is:

1. A voltage regulator comprising:
a MOS-type pass transistor, wherein a first channel of the pass transistor is connectable to a voltage source and wherein a second channel of the pass transistor is connected to the output of the voltage regulator; and
an error amplifier having a reference input and an output, the output being connected to the gate of the pass transistor, the reference input being connected to a reference voltage source.

2. The voltage regulator of claim 1 and further comprising a capacitor connected between the gate of the pass transistor and ground.

3. The voltage regulator of claim 1, wherein the closed-loop bandwidth of the error amplifier is below 20 kHz.

4. The voltage regulator of claim 1, wherein the closed-loop bandwidth of the error amplifier is below 10 kHz.

5. The voltage regulator of claim 1, wherein the pass transistor is an NMOS-type transistor and wherein the drain of the pass transistor is connectable to the voltage source and wherein the source of the pass transistor is connected to the output of the voltage regulator.

6. The voltage regulator of claim 1, wherein the pass transistor is an PMOS-type transistor and wherein the source of the pass transistor is connectable to the voltage source and wherein the drain of the pass transistor is connected to the output of the voltage regulator.

7. The voltage regulator of claim 1, wherein the error amplifier comprises an input stage and wherein the input stage comprises an AB class amplifier.

8. The voltage regulator of claim 1, wherein the current drawn by the error amplifier is proportional to the difference between the value of the reference voltage source and the voltage at the output of the regulator.

9. A voltage regulator comprising:
a pass transistor, wherein a first channel of the pass transistor is connectable to a voltage source and wherein a second channel of the pass transistor is connected to the output of the voltage regulator; and
an error amplifier having a reference input and an output, the output being connected to the gate of the pass transistor, the reference input being connected to a reference voltage source, and the error amplifier having an AB input stage.

10. The voltage regulator of claim 9, wherein the current drawn by the error amplifier is proportional to the difference between the value of the reference voltage source and the voltage at the output.

11. The voltage regulator of claim 9, wherein the input stage comprises a differential amplifier, the differential amplifier comprising:
a first transistor, wherein the reference input is connected to the gate of the first transistor;
a second transistor, wherein the output of the error amplifier is connected to the gate of the second transistor; and
a biasing transistor operative to bias current through the first transistor.

12. The voltage regulator of claim 9, wherein the input stage comprises a differential amplifier, the differential amplifier comprising:
a first feedback loop, wherein the reference input is connected to the first feedback loop; and
a second feedback loop, wherein the output of the error amplifier is connected to the second feedback loop;
wherein when the output load of the voltage regulator increases, the output voltage of the error amplifier drops and the bias current in the first feedback loop increases.

13. The voltage regulator of claim 12, wherein the bias current in the second feedback loop is proportional to the bias current in the first feedback loop.

14. The voltage regulator of claim 12, wherein the second feedback loop comprises:
a first transistor and a second transistor, wherein the gates of the first and second transistors are connected to the output of the error amplifier;
a third transistor biasing the current in the first transistor; and
a fourth transistor biasing the current in the second transistor;
wherein the source of the first transistor is connected to the second feedback loop; and
wherein the gate of the third transistor is connected to the gate of the fourth transistor.

15. The voltage regulator of claim 12, wherein the first feedback loop is configured substantially similar to the second feedback loop.

16. The voltage regulator of claim 9, wherein the input stage comprises a differential amplifier, the differential amplifier comprising:
a first feedback loop, wherein the reference input is connected to the first feedback loop;
a second feedback loop, wherein the output of the error amplifier is connected to the second feedback loop; and
a current biasing transistor that biases the current through the first feedback loop and the second feedback loop;
wherein when the output load of the voltage regulator increases, the output voltage of the error amplifier drops and the bias current in the first feedback loop increases.

17. The voltage regulator of claim 17 and further comprising a current selector connected to the differential amplifier.

18. The voltage regulator of claim 9 and further comprising a capacitor connected between the gate of the pass transistor and ground.

19. The voltage regulator of claim 9, wherein the closed-loop bandwidth of the error amplifier is below 20 kHz.

20. A voltage regulator comprising:
a pass transistor, wherein the drain of the pass transistor is connectable to a voltage source and wherein the source of the pass transistor is connected to the output of the voltage regulator; and
an error amplifier comprising:
a reference input connected to a reference voltage source;
an output, the output being connected to the gate of the pass transistor;
a differential amplifier having a first transistor and a second transistor, the gate of the first transistor being connected to the reference input, the gate of the second transistor being connected to the source of the pass transistor, and the drain of the second transistor being connected to the output of the error amplifier; and
a current mirror connected to the first transistor and the second transistor.
